(19) United States
(12) Patent Application Publication
(10) Pub. No.: US 2016/0321829 A1
(43) Pub. Date: Nov. 3, 2016

(54) PIXEL-BASED VISUALIZATION OF EVENT METRIC FLUCTUATION

(71) Applicant: HEWLETT-PACKARD DEVELOPMENT COMPANY, L.P., Houston, TX (US)

(72) Inventors: Ming C. Hao, Palo Alto, CA (US); Xin Zhang, San Jose, CA (US); Gregory W. Cook, Palo Alto, CA (US); Nelson L. Chang, San Jose, CA (US); Riddhiman Ghosh, Sunnyvale, CA (US); Meichun Hsu, Los Altos Hills, CA (US)

(73) Assignee: HEWLETT-PACKARD DEVELOPMENT COMPANY, L.P., Houston, TX (US)

(21) Appl. No.: 15/034,523

(22) PCT Filed: Jan. 31, 2014
(86) PCT No.: PCT/US2014/014222

§ 371 Date: May 4, 2016

(51) Int. Cl. G06T 11/20; G06T 11/00; G06T 13/80

(52) U.S. Cl. CPC G06T 11/206; G06T 13/80; G06T 11/001

(57) ABSTRACT

According to an example, fluctuations of a metric for events are determined. The fluctuations are for multiple time intervals. A pixel-based visualization of the fluctuations is generated, and the pixels represent amounts of the fluctuations.

### BACKGROUND

For many different types of applications, it is not uncommon to try to analyze events for various reasons. For example, weather specialists may analyze current weather conditions to try to detect hazardous conditions so they can provide warning of potentially hazardous weather. In another example, stock market analysts often try to determine the direction of stock movement to make buy and sell decisions. For these types of applications, a history of fluctuations in various factors may be analyzed.

### BRIEF DESCRIPTION OF DRAWINGS

The embodiments are described in detail in the following description with reference to examples shown in the following figures.

FIG. 1 illustrates an example of an event fluctuation detection and analysis system.

FIG. 2 illustrates an example of a pixel-based visualization in an x-y plane.

FIG. 3 illustrates an example of a radial pixel-based visualization.

FIG. 4 illustrates an example of a drill-down in a pixel-based visualization.

FIGS. 5A-F illustrate an example of animation of a pixel-based visualization and a zoom-in of the pixel-based visualization in the animation.

FIG. 6 illustrates an example of method for generating a pixel-based visualization.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It is apparent that the embodiments may be practiced without limitation to all the specific details. Also, the embodiments may be used together in various combinations.

An event fluctuation detection and analysis system according to an example determines fluctuations of a metric or multiple metrics during a short period of time, such as fluctuations every millisecond, second, every minute or over other durations. The detection of fluctuations of the metric over the time period can be performed over multiple events, e.g., fluctuations for multiple stocks or for multiple weather conditions which may be at multiple locations, simultaneously. An event is something that happens or is regarded as happening and the event may have a metric or multiple metrics to describe or measure the event. A fluctuation or percentage fluctuation of a stock are examples of an event and they have stock price as a metric for measuring happenings for the stock. Another example of an event is a weather condition, such as a hurricane or tornado, and metrics may include wind speed, temperature, etc. The values of a metric over time can be correlated to the values of the same metric of a different event or a different metric of the same or different event by the system or by a user viewing the pixel-based visualization described below. The event fluctuation detection and analysis system can generate pixel-based visualizations of the fluctuations, which may include co-occurring impact factors that can cause the fluctuations. For example, the event fluctuation detection and analysis system can compute a change in fluctuation of the metric over a short duration to detect multiple event fluctuations at a high granularity, such as computing the fluctuation of stock prices for multiple stocks every minutes or every seconds; align the fluctuations by time along with co-occurring impact factors, such as news, sentiment, product reviews, etc., in a pixel space; and generate real-time animation of the fluctuations aligned with the co-occurring impact factors to facilitate detection of moving patterns. The animation includes an animation of the pixel-based visualization over time.

A pixel-based visualization for example includes a pixel representing an amount of fluctuation for each time period. For example, a pixel may be provided for each second and represents an amount of change of the metric over the second. The amount of change or amount of fluctuation may be based on a highest value and lowest value for the time interval. For example, a stock price may vary by 0.002, which is a difference from a highest stock price to lowest stock price in the second. Percentage fluctuation is another example of computing an amount of fluctuation and is further described below. The color and/or brightness of the pixel for example is determined from the value (e.g., 002) of the amount of change of the metric for the time period. For example, a larger amount of change is represented by a darker color in a color scale or a darker shade in grey-scale than a pixel representing a smaller amount of change.

The examples of the present disclosure are generally described by way of example with respect to measuring and analyzing stock price fluctuations for multiple stocks whereby each stock percentage fluctuation is considered an event. However the examples of the present disclosure can be applied to many different types of events and related metrics, such as weather events, computer network events, energy consumption events and healthcare events. The events can be analyzed to detect patterns or anomalies and to react to them accordingly.

Unlike conventional line charts for analyzing historic data, the event fluctuation detection and analysis system is able to generate pixel-based visualizations that allow a user to observe changes in a fine-grained scale, e.g., from minute-to-minute or second-to-second, depending on the application needs. Also, the system concurrently incorporates impact factors, such as sentiment, company productivity and profitability, etc., in the pixel-based visualization to facilitate determination of the root cause of the fluctuations. Also, the pixel-based visualization and animation are user interactive. A user interactive visualization or user interactive animation for example allows user selection of one or more pixels which can invoke an action, such as a drill-down or zoom-in display of a selection. The drill-downs and zoom-ins can provide detailed information regarding metrics and impact factors in selected time periods. Furthermore, according to an example, the system can generate fine-grained visualization, such as pixels that represent a percentage fluctuation every millisecond or every second or every minute or for another time interval between a millisecond and a minute inclusive. This fine-grained visualization allows the user to detect patterns and/or anomalies, such as a high percentage fluctuation over multiple stocks in short time intervals, that otherwise would not be detectable in time intervals of a longer duration.

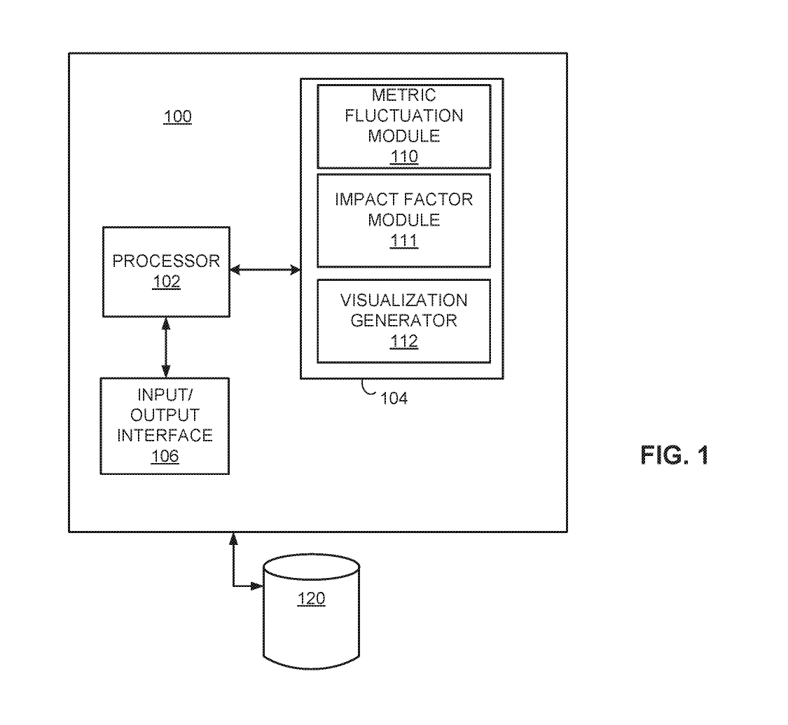

FIG. 1 illustrates an event fluctuation detection and analysis system 100 according to an example. It should be understood that the system 100 may include additional components and that one or more of the components described herein may be removed and/or modified without departing from a scope of the system 100.

The system 100 may be embodied on a computer including, for example, a processor 102, a data storage device 104, and an input/output interface 106. In one example, the computer is a server but other types of computers may be used, Also, the components are shown in a single computer as an example and in other examples the components may exist on multiple computers and the components may comprise multiple processors, data storage devices, interfaces, etc.

The data storage device 104 may include a hard disk, memory, etc. The data storage 104 may store any data used by the system 100. The processor 102 may be a microprocessor, a micro-controller, an application specific integrated circuit (ASIC), field programmable gate array (FPGA), or other type of circuit to perform various processing functions.

In one example, the system 100 comprises machine readable instructions stored on a non-transitory computer readable medium, such as the data storage device 104, and executed by the processor 102 to perform the functions of the system 100. For example, the system 100 may include a metric fluctuation module 110, an impact factor module 111, and a visualization generator 112 stored on the data storage device 104 as shown in FIG. 1. In another example, the system 100 includes a customized circuit, such as the ASIC, FPGA, etc,, to perform a function or multiple functions of the system 100. For example, the metric fluctuation module 110, the impact factor module 111, and/or the visualization generator 112 may be embodied as an FPGA or ASIC or an embedded system.

The input/output (I/O) interface 106 comprises a hardware and/or a software interface. The I/O interface 106 may be a network interface connected to a network, such as the Internet, a local area network, etc. The system 100 may receive metrics and user-input through the I/O interface 106. The system 100 may generate the pixel-based visualizations and provide the pixel-based visualizations to the user via the I/O interface 106 or may include a display to display the visualizations.

The system 100 may be connected to a database 120 or other type of data storage system to store measurements and values for metrics and impact factors. Any type of data used by the system 100 may be stored in the database 120. The database 120 may be hosted on a separate computer such as a database server and some of the information used by the system 100, for example data for generating the visualizations, may be stored locally to provide real-time animation of the fluctuations.

As discussed above, the system 100 may include the metric fluctuation module 110, the impact factor module 111, and the visualization generator 112. The metric fluctuation module 110 determines an amount of change of a metric for an event over a duration. According to an example, the metric fluctuation module 110 computes a percentage fluctuation of the metric, such as stock price fluctuation, over each duration, such as every second, every minute, etc. The computation can be performed over multiple events, such as for multiple stocks, simultaneously. An example of the computation for computing the percentage fluctuation of the metric is as follows:

$$f ( Δ {x}_{i} ) = 1 - \frac{{low}_{x ∈ Δ {x}_{i}} eventValue ( x )}{{high}_{x ∈ Δ {x}_{i}} eventValue ( x )} \qquad Equation ( 1 )$$

where eventValue(x) is the value of the metric (e.g., stock price) for which the computation is performed and eventValue(x)≧0∀x. Δxᵢ is the time interval to be analyzed, and f(Δxᵢ) is the percentage fluctuation of the value of the metric over the interval Δxᵢ. Low eventValue(x) is the lowest eventValue in the time period and high eventValue(x) is the highest eventValue in the time period. The percentage fluctuation for example has a minimum value of zero and a maximum of unity, such as 1.

The metric fluctuation module 110 may obtain the values for the metric and calculate the percentage fluctuation of the value of the metric over consecutive intervals in real-time to generate the pixel-based visualizations in real-time. The values for the metric may be obtained from external sources.

The impact factor module 111 obtains or calculates values for impact factors that are associated with the metric and event. The impact factors are factors that may cause or influence fluctuations of the metric for the event. For example, sentiment, product ratings, news, and profits are examples of impact factors that may influence the metric of stock price for a stock. Values of the impact factors may be obtained from external sources. The impact factor module 111 may perform a time correlation of values for impact factors with metric values. For example, a stock price is determined for a particular time interval. A measurement for an impact factor taken is also determined for the same time interval, and the stock price and the measured impact factor are identified as being for the same time interval. The values may be received and/or stored with an indicator identifying their associated time interval. This information may be used to align metric values with impact factor values for the pixel-based visualization.

The visualization generator 112 generates pixel-based visualizations of the fluctuations of metric values and impact factors for multiple events. Examples of the pixel-based visualizations are described below. Also, the visualization generator 112 facilitates selection and drill-downs on metrics as is further described below. Furthermore, the visualization generator 112 can generate an animation to show the fluctuations and facilitate detection of moving patterns. Through the drill-down capability of the system 100, users may access the data points during the animation.

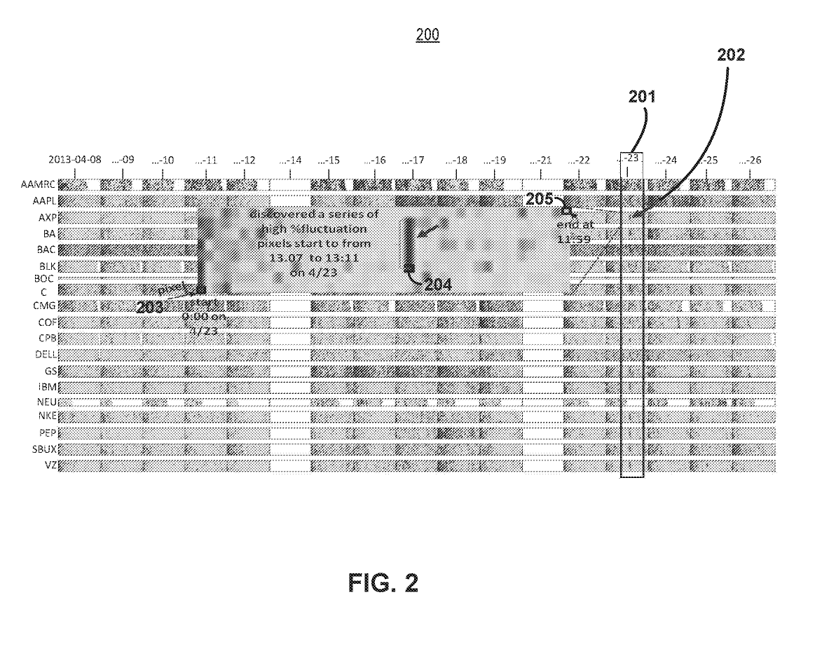

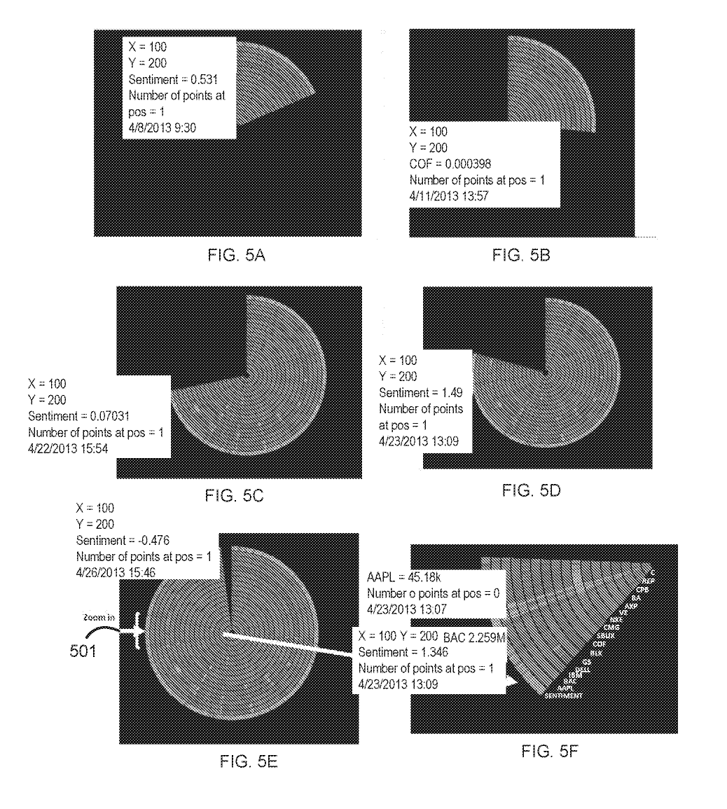

FIGS. 2-4 show examples of pixel-based visualizations that may be generated by the system 100. FIGS. 5A-F shows an example of an animation of a pixel-based visualization that may be generated by the system 100. In one example, the pixels may have grey-scale values that correspond to a percentage fluctuation value. In another example, the pixel-based visualizations may include color pixels. The color of the pixel is indicative for example of the percentage fluctuation of the metric over a time interval. For example, each percentage fluctuation value maps to a particular color on a scale. In one example, the colors on the scale range from purple to blue to green to yellow and to orange representing a range of percentage fluctuation values from smaller to larger respectively. The pixels shown in FIGS. 2-5 are color pixels converted to grey-scale so the figures comply with drawing requirements for an international patent application. However, in a real-world implementation, the pixels can be shown in their corresponding colors. In the grey-scale representation shown in FIGS. 2-5, the darker pixels generally represent pixels that are orange or a shade of orange that correspond to higher percentage fluctuation values than the lighter pixels shown in FIGS. 2-5 which generally represent pixels that are on the lower-end of the scale which have lower percentage fluctuation values.

The pixel-based visualization shown in FIG. 2 includes pixels representing percentage fluctuation values for stocks from April 23^{rd} through April 28^{th}. In this example, the pixel-based visualization includes pixels in a plane with an x and y axes. For example, the x-axis shows the date range and the y-axis shows the stock symbols. Each stock's percentage fluctuation for example is an event and thus the visualization shows percentage fluctuations simultaneously for multiple events. Each pixel for example represents a percentage fluctuation for a one-minute time interval. A column of pixels for each stock for example represents a ten-minute interval.

The pixels for all the stocks are aligned by their occurrence in time. For example, a column along the y-axis in the plane represents the same time interval over all the stocks shown in the visualization. Displaying the pixels so their corresponding intervals are aligned in the visualization by time allows patterns of . high fluctuations in stock price to be identified for consecutive short time intervals across multiple stocks. An example of a pattern of high fluctuations in stock price for the same time interval and manifesting over multiple stocks is highlighted by box 201. In box 201, a dark line is shown for the same 5-7 minute time interval across multiple stocks. This is illustrating that multiple stocks are experiencing high fluctuations in stock price over the same time interval. Furthermore, the visualization also illustrates that this pattern is unusual for the time of day that the high fluctuations are occurring. As shown in FIG. 2, it is not uncommon for high fluctuations in stock price to occur at the beginning and end of the training day. However, it is unusual for this pattern to occur in the middle of the day across multiple stocks. The distinction between the typical and unusual patterns is quickly and easily identifiable by a user by identifying the dark pixels in the same column across multiple stocks in the middle of the trading day versus the beginning and ending of each trading day. The user may react accordingly by buying or selling the stock.

202, which is shown in box 201, represents the pixels for AXP for the 5-7 minute time interval described above whereby most of the stocks are experiencing high fluctuations in the middle of the trading day. For example, as shown in FIG. 2, 202 includes pixels from 13:07 to 13:11 on April 23rd. 204 for example identifies the pixel for the one-minute time interval for 13:07. 203 to 205, which includes all the pixels between 203 and 205, identify pixels in April 23rd for the AXP stock. 203 is the pixel for the first minute of the trading day and 205 is the pixel for the last minute of the trading day.

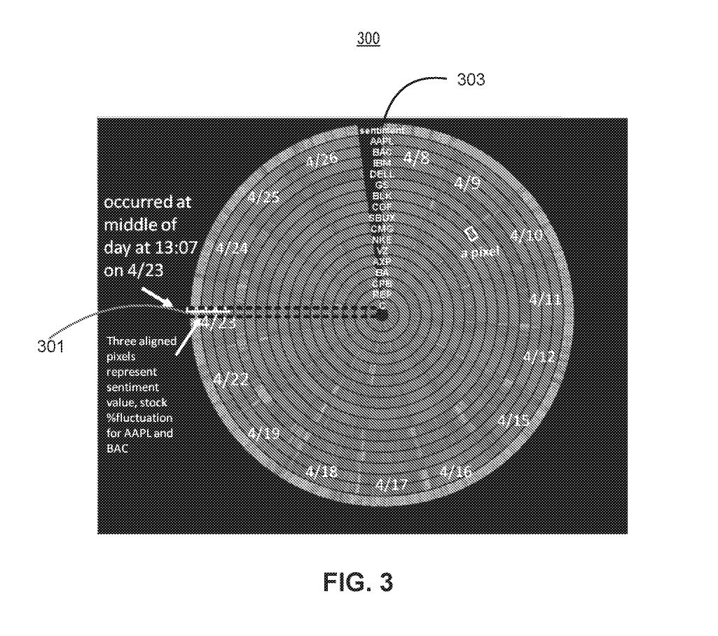

FIG. 3 shows a radial representation of the percentage fluctuations shown in FIG. 2. In FIG. 3, the pixels representing percentage fluctuations are also aligned by time and a radius identifies percentage fluctuations for the same time interval across multiple stocks, Also, the color of the pixel is based on the value of the percentage fluctuation for the time interval of the pixel, which is the same as in FIG. 2.

Values for co-occurring impact factors can be included in the pixel-based visualizations. The values for these factors may come from various sources. Values for the impact factors may be in the last row of an x-y pixel plane. In a radial representation, the values may be provided as a ring. For example, FIG. 3 shows the outermost ring 303 representing sentiment for stocks and is aligned by time with the percentage fluctuations. The color of the pixels in the sentiment ring may be based on a similar color scale as the percentage fluctuations. For example, a red pixel (e.g., a darker pixel shown in the outermost ring 303) represents negative sentiments and a blue pixel (e.g., a lighter pixel shown in outermost ring 303) represents positive sentiments on the color scale. The scale may have multiple colors, such as blue for positive, red for negative and green for neutral sentiment. In FIG. 3, 301 shows the high percentage fluctuations across multiple stocks at 13:07 on April 23rd, similar to 201 in FIG. 2. Also, the sentiment pixels in the outermost ring 303 are dark (e.g., negative sentiment) for the same time interval and across multiple stocks. Accordingly, a user may deduce the high fluctuations are caused at least in part by the negative sentiment and can react accordingly.

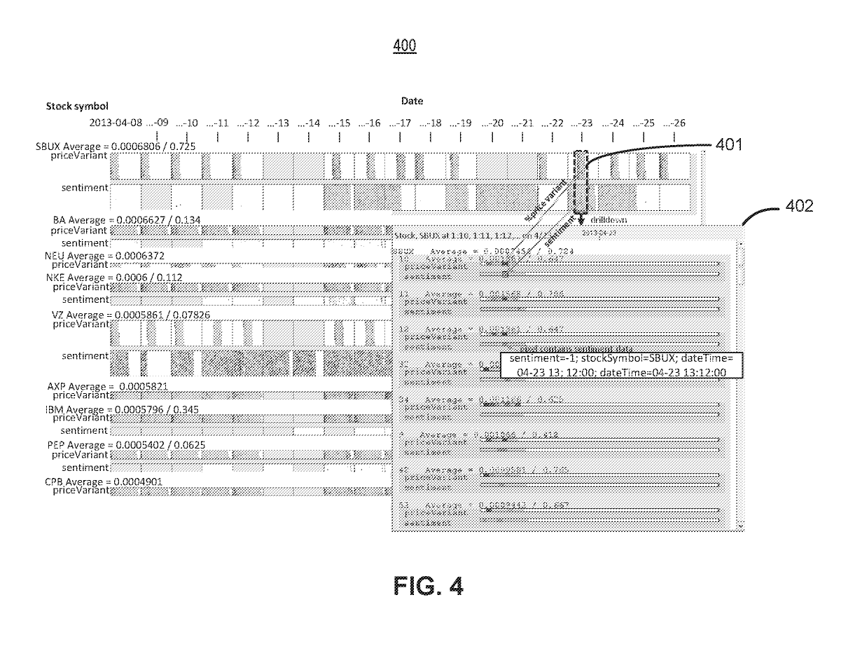

FIG. 4 shows an example of a drill-down. For example, a user may select an area of interest, such as area 401, on a pixel-based visualization generated by the system 100. Details for the selected area 401 are shown for example in a window 402. The details may include values for pixels in the selected area 401, such as values for metrics or impact factors corresponding to the time interval and stock in the selected area 401. The area 401 includes pixels for percentage fluctuation and sentiment for the SBUX stock. The pixels are in the time interval from 13:10 to 13:52 on April 23rd. For example, a social network message with negative sentiment is sent at 13:07 on April 23rd. Both the percentage fluctuation and sentiment values are changing at the same pace at this time in reaction to the message. For example, the percentage fluctuation is high and the sentiment is negative during 1:10 to 1:12 pm on April 23rd and the price falls. This correlation is also shown in FIGS. 5E-F.

FIGS. 5A-F show examples of frames from an animation including pixel-based visualizations that may be generated by the system 100. The animation is of the radial representation shown in FIG. 3. For example, FIG. 5A shows pixels representing the percentage fluctuations and sentiment for April 8th. FIG. 5A shows high percentage fluctuations at the beginning and ending of trading day and low percentage fluctuations during the middle of the trading day.

FIG. 5B shows pixels for April 8^{th} through April 11^{th}. Stock trading remains in the same patterns as the previous trading day, such as high percentage fluctuations at the beginning and ending of the trading day and low percentage fluctuations during the middle of the trading day. FIG. 5C shows pixels for stock trading days ending on April 22^{nd} and FIG. 5D shows pixels for stock trading days ending on April 23^{nd} at a time after 1 PM. In FIG. 5C, the stock trading pattern remains the same as the previous days. In FIG. 5D, the stock trading pattern suddenly changes such as described with respect to FIG. 3. In FIG. 5D, for April 23^{rd}, from 13:07 to 13:17 unexpected stock percentage fluctuations are observed and are high as opposed to previous days for that time frame from 13:07 to 13:17.

FIGS. 5E and 5F show that the animation may be interactive. For example, in FIG. 5E, the user may select a zoom area 501 that is of interest to the user. The zoom area 501 includes the mid-day pattern detected for April 23^{rd}. FIG. 5F shows the selected zoom area 501 after it is selected. For example, a user can mouse over a pixel to read the values.

The pixel-based visualizations and animations generated by the system 100 may be generated in real-time or to analyze historic data. For real-time analysis, the visualizations and animations for example may be generated as soon as the data for the events are received. For historical analysis, data from previous time intervals for which data is stored may be retrieved to generate the visualizations and animations.

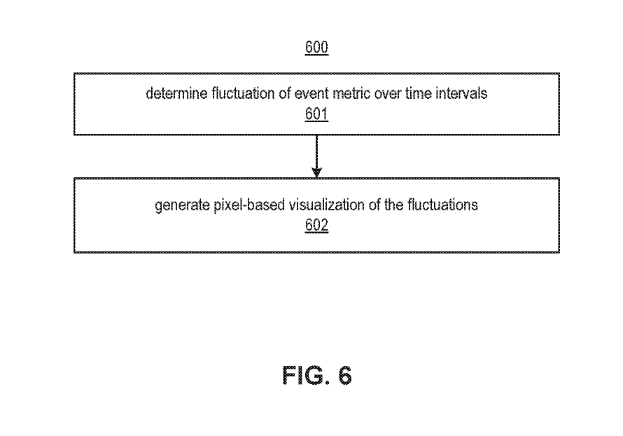

Method 600 shown in FIG. 6 describes generating a pixel-based visualization including metric fluctuations, such as the examples shown in FIGS. 2-5. The method 600 may be performed by the system 100 shown in FIG. 1 and/or other systems.

At 601, the system 100 determines a fluctuation of a metric for an event over time intervals. For example, the metric fluctuation module 110 of the system 100 determines a fluctuation of a metric for an event over a time interval. The time interval may be a short duration, such as every second, every 10 seconds, every minute, every 5 minutes, etc. The fluctuation may be determined over consecutive time intervals for a longer duration, such as determining fluctuation in stock price every second over an entire trading day. In one example, the fluctuation is the percentage fluctuation described above in Equation (1). Also, the fluctuations may be determined for multiple events, which may be computed simultaneously. For example, the percentage fluctuations are computed for multiple stocks simultaneously.

At 602, a pixel-based visualization of the fluctuations is generated. For example, the visualization generator 112 of the system 100 generates a pixel-based visualization of the fluctuations in the metric for an event or multiple events. Examples of the pixel-based visualization are shown in FIGS. 2-5.

The system 100 allows a user to detect patterns or anomalies by viewing the pixel-based visualization. Also, the system 100 itself may detect the patterns or anomalies and perform an action in response to the detection. For example, the system 100 may store thresholds, such a percentage fluctuation threshold. If the threshold is exceeded by events for multiple stocks in one interval or multiple consecutive intervals, then an action may be performed, such as generating an alert, executing a stock trade, etc. This detection and execution of an action may be performed prior to the display of the pixel-based visualization, during the display and/or after the display.

A pixel in a pixel-based visualization, for example, is a point or small area in a pixel space. Together, the pixels form the pixel-based visualization. A pixel value of a pixel in the pixel-based visualization, for example, is or is represented by the amount of fluctuation in a metric for an event for a time interval. For example, if percentage fluctuation is determined every second for a stock price for a trading day, the computed percentage fluctuation for a second is the pixel value for a pixel for that second. Accordingly, a pixel may be generated for each second of the trading day for the stock.

The color or shade of the pixel may be determined according to the pixel value. For example, the amount of fluctuation in one second (e.g., percentage fluctuation) is associated with color value or grey-scale value that identifies a particular color or shade. Thus, different percentage fluctuations may be associated with different colors or different shades. This is illustrated in the examples of the pixel-based visualizations described above and shown in FIGS. 2-5. For example, a range of percentage fluctuations are associated with a range of pixel values, each representing a different color or different shade in grey-scale. For example, pixel values may represent different colors ranging from different shades of orange at the upper end, different shades of yellow in the middle, and different shades of purple and blue at the lower end. Each color may correspond to a percentage fluctuation value in a range. For example, high percentage fluctuation values may be shades of orange, middle percentage fluctuation values may be shades of yellow and lower percentage fluctuation values may be shades of purple and blue.

Also, pixels for multiple events may be aligned by time, For example, pixels for the same time interval and for multiple events are aligned linearly. For example, the pixels for the same time interval are in the same column, such as shown in FIG. 2, or are in the same row, in an x-y plane, pixel-based visualization. In another example, pixels for the same time interval for multiple events are linearly arranged in the same radius in a radial, pixel-based visualization, such as shown in FIG. 3. For example, pixels in each ring show percentage fluctuations for the stock corresponding to the ring, and a radius shows percentage fluctuations for the same time interval across multiple stocks.

Also, an impact factor or multiple impact factors may be shown in a pixel-based visualization, and pixels for the impact factor may also be aligned by time. For example, FIG. 3 shows pixels in the outermost ring 303 that represent values for sentiment for a stock or multiple stocks. The sentiment values in a radius are for the same time interval as the percentage fluctuations of the stocks in the radius. Also, as described above, pixel-based visualizations may include animations. Also, drill-downs and zoom-ins maybe performed on a pixel-based visualization.

While the embodiments have been described with reference to examples, various modifications to the described embodiments may he made without departing from the scope of the claimed features.

What is claimed is:

1. An event fluctuation detection and analysis system comprising:
a metric fluctuation module, executed by at least one processor, to determine fluctuations of a metric for a plurality of events and for a plurality of time intervals; and
a visualization generator, executed by the at least one processor, to generate a pixel-based visualization of the fluctuations, wherein pixels form the pixel-based visualization, and the pixels represent amounts of the fluctuations.

2. The event fluctuation detection and analysis system of claim 1, wherein each pixel corresponds to a time interval of the plurality of time intervals, and a color or shade of each pixel is determined from the amount of fluctuation determined for the corresponding time interval.

3. The event fluctuation detection and analysis system of claim 1, wherein the pixels for the multiple events are aligned by time and wherein pixels for the same time interval and for different events are linearly arranged.

4. The event fluctuation detection and analysis system of claim 1, comprising:
an impact factor module to determine fluctuations in an impact factor for the plurality of events and for the plurality of time intervals, wherein the pixel-based visualization includes pixels that represent the fluctuations in the impact factor.

5. The event fluctuation detection and analysis system of claim 1, wherein the pixels for the fluctuations in the metric and the fluctuations in the impact factor are aligned by time, and pixels in the pixel-based visualization for the same time interval and for different events are linearly arranged.

6. The event fluctuation detection and analysis system of claim I the pixel-based visualization is a user interactive visualization that allows a user selection of at least one pixel for a drill down and display of information related to the at least one pixel.

7. The event fluctuation detection and analysis system of claim 6, wherein the information includes impact factor fluctuation amount values for the selection.

8. The event fluctuation detection and analysis system of claim 1, wherein the visualization generator is to generate an animation of the pixel-based visualization over consecutive time periods.

9. The event fluctuation detection and analysis system of claim 8, wherein the visualization generator is to receive a selection of an area during the animation and display a zoom-in of the selected area with fluctuation amount values for at least one of the metric and an impact factor.

10. The event fluctuation detection and analysis system of claim 1, wherein the pixel-based visualization is an x-y plane pixel-based visualization including the plurality of events on one axis and the plurality of time intervals on another axis, and the pixels are located in the x-y plane pixel-based visualization according to the corresponding time interval and event for the pixel.

11. The event fluctuation detection and analysis system of claim 1, wherein the pixel-based visualization is a radial pixel-based visualization including a plurality of rings representing the plurality of events and radii corresponding to the plurality of time intervals.

12. A non-transitory computer readable medium including machine readable instructions executable by at least one processor to:
determine fluctuations of a metric for a plurality of events and for a plurality of time intervals; and
generate a pixel-based visualization of the fluctuations, wherein pixels form pixel-based visualization, and the pixels represent amounts of the fluctuations.

13. The non-transitory computer readable medium of claim 12, wherein each pixel corresponds to a time interval of the plurality of time intervals, and a color or shade of each pixel is determined from the amount of fluctuation determined for the corresponding time interval.

14. The non-transitory computer readable medium of claim 12, wherein each of the amounts of the fluctuations are computed as a function of a highest metric value and a lowest metric value determined for the corresponding time interval.

15. A method comprising:
determining fluctuations of a metric for a plurality of events and for a plurality of time intervals, wherein each time interval is in a range from 1 millisecond to 1 minute;
determining fluctuations in an impact factor for the plurality of events and for the plurality of time intervals; and
generating a pixel-based visualization of the fluctuations, wherein pixels form the pixel-based visualization, and the pixels represent amounts of the fluctuations for the metric and the impact factor and wherein the pixel-based visualization is a user interactive visualization that allows a user to select at least one pixel for a drill down and display of information related to the at least one pixel,
wherein each pixel corresponds to a time interval of the plurality of time intervals, and a color or shade of each pixel is determined from the amount of fluctuation of the metric or the impact factor determined for the corresponding time interval, and
wherein the pixels for the multiple events are aligned by time, and pixels for the same time interval and for different events are linearly arranged.
